(19) United States
(12) Patent Application Publication
(10) Pub. No.: US 2012/0042759 A1
(43) Pub. Date: Feb. 23, 2012

(54) SOIL PIPE CUTTER JAW FOR PRESS TOOL AND RELATED METHODS

(75) Inventor: Brian A. Mitchell, North Olmsted, OH (US)

(73) Assignee: EMERSON ELECTRIC CO., St. Louis, MO (US)

(21) Appl. No.: 12/858,793

(22) Filed: Aug. 18, 2010

(51) Int. Cl. B23D 55/10; B23D 53/10

(52) U.S. Cl. 83/54; 83/814

(57) ABSTRACT

A cutting tool is described. The tool engages with a standard press tool and is used for cutting brittle pipe such as cast iron soil pipe. The tool features a cutting chain assembly that is tensioned about the pipe by a pair of pivotally moveable arms.

### FIELD OF THE INVENTION

The present invention relates to a portable tool system and a tool accessory for cutting relatively brittle pipe such as cast iron soil pipe. The invention also relates to methods of cutting and scoring pipe using the tool.

### BACKGROUND OF THE INVENTION

A wide array of soil pipe cutters are known in the art. Many of these use lever arms that transmit force to a ratchet assembly which in turn tensions a cutting chain wrapped about a pipe to be cut. Typically, such lever arms are relatively long in order for a user to generate the requisite amount of force for advancing the ratchet assembly and tightening the chain. When cutting soil pipe, and particularly previously installed pipe sections, access to the pipe is usually limited. For example, for buried pipe, after exposing the pipe by digging, the walls of the trench or hole frequently limit the degree of access around the pipe. As will be appreciated, it is undesirable to continue digging additional areas around the pipe to increase access. Also, limited access may exist for pipe installed in walls or under floors in buildings or other structures. Thus, while the use of cutters using lever arms is acceptable for uninstalled pipe, such cutters are not preferred and in many instances entirely unacceptable for situations in which pipe access is limited.

Another type of soil pipe cutter utilizes a scissor mechanism. The scissor mechanism is expanded or collapsed at one end to generate an opposite but amplified force at another end of the mechanism, at which a cutting chain is attached. Thus, operation of a scissor mechanism typically involves an expansion of the assembly at least somewhere around the region of pipe to be cut. Although satisfactory in many regards, the scissor mechanism can become obstructed or otherwise interfered with when attempting to cut pipe in limited access environments.

Additional examples of pipe cutters include pipe cutting systems using relatively large work surfaces or tables for supporting a pipe and an enclosure for housing a power assist system for tensioning the cutting chain. Although satisfactory for cutting free or uninstalled sections of pipe, these devices are not appropriate for limited access cutting situations such as for installed or buried pipe. Furthermore, these devices are not amenable for transport from one cutting site to another.

Accordingly, a need remains for a portable, relatively small pipe cutter that is free of bulky components such as lengthy lever arms and expandable scissor mechanisms.

### SUMMARY OF THE INVENTION

The present invention provides a cutting tool using a cutting chain that is tensioned about a pipe to be cut. The tool is engaged with a conventional press tool. Operation of the press tool and displacement of a pair of pivotably movable arms of the cutting tool causes tightening of the cutting chain and subsequent fracture and/or cutting of the pipe. The cutting tool can accommodate a variety of different size pipes.

The difficulties and drawbacks associated with previously known tools and systems are addressed in the present system, apparatus, and method for a pipe cutting tool.

In one aspect, the invention provides a pipe cutting tool adapted for engagement to a press tool having an extendable powered ram. The cutting tool comprises a frame assembly defining a first region and a second region. The tool also comprises a first arm pivotally engaged with the first region of the frame assembly. The first arm defines a proximal end and an opposite distal end. The cutting tool further comprises a second arm pivotally engaged with the second region of the frame assembly. The second arm defines a proximal end and an opposite distal end. The tool additionally comprises a pivot plate assembly pivotally engaged with the distal end of the second arm. The pivot plate assembly defines a first locale and a second locale. The tool also comprises a cutting chain attached to the distal end of the first arm and also attached to the first locale of the pivot plate assembly. And, the tool comprises a feedscrew assembly engaged with the second arm and the second locale of the pivot plate assembly. Upon adjustment of the feedscrew assembly, the position of the pivot plate assembly relative to the second arm is changed, thereby changing the cutting confine defined by the cutting chain.

In another aspect, the invention provides a pipe cutting tool adapted for engagement to a press tool having an extendable powered ram. The cutting tool comprises a frame assembly defining a first region and a second region. The tool also comprises a first arm pivotally engaged with the first region of the frame assembly. The first arm defines a proximal end and an opposite distal end. The tool also comprises a second arm pivotally engaged with the second region of the frame assembly. The second arm defines a proximal end and an opposite distal end. The tool further comprises a pivot plate assembly pivotally engaged with the distal end of the second arm. The pivot plate assembly includes a first pivot plate and a second pivot plate. The first and second pivot plates are spaced apart and pivotably coupled to the distal end of the second arm disposed therebetween. The first and second plates define a first aperture and a second aperture. The cutting tool also comprises a cutting chain attached to the distal end of the first arm and also attached to the first aperture defined by the pivot plates. And, the tool further comprises a feedscrew assembly engaged with the second arm and the second aperture of the pivot plates. Upon adjustment of the feedscrew assembly, the position of the pivot plate assembly relative to the second arm is changed, thereby changing the cutting confine defined by the cutting chain.

In still another aspect, the present invention provides a pipe cutting tool adapted for engagement to a press tool having an extendable powered ram. The cutting tool comprises a frame assembly defining a first region and a second region. The tool also comprises a first arm pivotally engaged with the first region of the frame assembly. The first arm defines a proximal end and an opposite distal end. The tool also comprises a second arm pivotally engaged with the second region of the frame assembly. The second arm defines a proximal end and an opposite distal end. The tool further comprises a pivot plate assembly pivotally engaged with the distal end of the second arm. The pivot plate assembly defines a first locale and a second locale. The tool also comprises a cutting chain attached to the distal end of the first arm and also attached to the first locale of the pivot plate assembly. And, the cutting tool comprises a feedscrew assembly engaged with the second arm and the second locale of the pivot plate assembly. The feedscrew assembly includes a longitudinal threaded member defining a proximal end and an opposite distal end, a support base projecting from the second arm, the base defining a slotted receiving region, and a trunnion defining a threaded bore extended through the trunnion. The longitudinal threaded member is threadedly engaged within the bore of the trunnion. The trunnion is supported and retained by the support base. And, the distal end of the longitudinal threaded member is engaged with the second locale of the pivot plate assembly. Upon adjustment of the feedscrew assembly, the position of the pivot plate assembly relative to the second arm is changed, thereby changing the cutting confine defined by the cutting chain.

In yet an additional aspect, the invention also provides a method of cutting a pipe. The method comprises providing a pipe cutting tool including a frame assembly, a first arm pivotally engaged with the frame assembly, the first arm defining a proximal end and an opposite distal end, a second arm pivotally engaged with the frame assembly, the second arm defining a proximal end and an opposite distal end, a pivot plate assembly pivotally engaged with the distal end of the second arm, a cutting chain attached to the distal end of the first arm and also attached to the pivot plate assembly, and a feedscrew assembly engaged with the second arm and the pivot assembly. The tool is in operable engagement with a press tool. The method also comprises providing a pipe to be cut. The method further comprises identifying a desired cutting location on the pipe. The method then involves positioning the cutting chain of the cutting tool about the pipe and generally co-extending with the desired cutting location. The method also comprises removing at least a portion of slack from the cutting chain by adjusting the feedscrew assembly. And, the method comprises actuating the press tool to cause powered pivotal displacement of the first arm and the second arm thereby tightening the cutting chain about the pipe thereby resulting in cutting of the pipe.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a rear perspective view of a preferred embodiment tool in accordance with the present invention.

FIG. 2 is a front perspective view of the preferred embodiment tool depicted in FIG. 1.

FIG. 3 is a schematic side elevational view of the preferred embodiment tool shown without certain frame components.

FIG. 4 is an exploded assembly view of another preferred embodiment tool in accordance with the present invention.

FIG. 5 is a schematic side elevational view of another preferred embodiment tool.

### DETAILED DESCRIPTION OF THE EMBODIMENTS

The present invention provides a device for conveniently and quickly cutting relatively brittle pipes such as cast iron soil pipes. The device is adapted for selective and releasable engagement to a powered press tool and utilizes the action of the hydraulic cylinder and/or ram or other powered cylinder of the press tool to tension a cutting chain, which when positioned about a pipe, readily severs or cuts the pipe. The terms “cut” or “cutting” as used herein refer to any type of action in which the targeted pipe is cut, severed or otherwise fractured generally along a desired or targeted location to result in the formation of multiple sections of the pipe or workpiece.

The cutting tool of the present invention is preferably adapted for use with a portable, hand-held press tool such as the CT-400 Press Tool, 320-E Press Tool, RP 330-B Press Tool, and RP 330-C Press Tool, all available from Ridge Tool Company of Elyria, Ohio under the designation RIDGID® Tools. It is also contemplated that the present invention tool if appropriately modified, can also be used with other press tools such as the Compact 100-B Press Tool and the Compact 210-B Press Tool, both available from Ridge Tool Company. However, the present invention cutting tool is not limited to use with only the previously noted press tools, as other press tools from other suppliers may also be acceptable. Generally, any press tool can be used in conjunction with the present invention cutting tool so long as the requisite press force and power can be delivered to the cutting tool and the mounting arrangements meet dimensional compatibility with the noted RIDGID® press tools. The preferred press tool for use with the present invention is of the type used for providing a press force to a removable jaw set engaged to the tool. Generally such press tools operate by activation of an internal electric motor which powers a hydraulic pump. The pump forces fluid into an onboard cylinder of the tool, thereby forcing a ram outward and applying thousands of pounds of press force to a jaw set that is engaged with the press tool. The present invention cutting tool is used in place of the jaw set. Examples of representative press tools besides the noted tools that may be suitable for use with the present invention cutting tool include, but are not limited to the press tools described in U.S. Pat. No. 7,124,608. These aspects are described in greater detail in conjunction with details of the preferred embodiments.

in accordance with the present invention, a preferred embodiment cutting tool is adapted to engage a press tool, and specifically, at the area of the press tool at which a press jaw set would be engaged. The cutting tool generally comprises a frame or support assembly, a set of pivotably movable arms, and one or more cutting chains or cutting chain sections generally releasably attached or secured to the arms. The cutting tool is used by attachment to a press tool, such as the previously noted Compact Press Tool 330-B from Ridge Tool Company. The cutting chain or the cutting chain sections are positioned about the outer periphery of a pipe or other workpiece to be cut or severed. The press tool is activated so that a hydraulic ram of the press tool is displaced toward the cutting tool attached to the press tool. The ram engages the set of pivotable arms of the cutting tool. As rear portions of the arms are displaced outward from one another, the front or distal ends of the arms are displaced toward one another, thereby tightening the cutting chain about the pipe or workpiece. Continuing displacement of the press tool hydraulic ram results in application of large forces to the cutting chain.

More specifically, the frame or support assembly of the cutting tool is preferably releasably engagable with a press tool. That is, for the previously noted Compact 330-B Press Tool, a removable jaw set is disengaged from the tool, and in its place, the present invention cutting tool is inserted. The frame or support assembly of the cutting tool defines a first or proximate end adapted for engagement with the press tool, and a second or distal end opposite from the first end. The terms “proximal” and “distal” are frequently used herein in describing the cutting tool and its various components. The term “proximal” denotes a location that is near or relative to the end of the cutting tool that is closest to a press tool when the cutting tool is engaged therewith. And, the term “distal” denotes a location that is away from the end of the cutting tool frame at which the cutting tool is attached to a press tool. Typically, the distal end is the end opposite from the proximal end.

Although the preferred embodiment tools are generally described herein as selectively attachable to and removable from a press tool, it will be understood that the invention includes versions in which the preferred embodiment cutting tools are permanently attached or integrally formed with an assembly providing a powered ram. In such a configuration, a one-piece or stand alone tool is provided having both a cutting tool head and a base portion with provisions for providing a powered ram or like component. For purposes of understanding the invention, the various preferred embodiments are in the form of a selectively engageable cutting tool which, as described herein, can be attached to and removed from a press tool. But, in no way is the invention limited to this particular configuration.

As previously noted, the preferred embodiment cutting tools generally comprise a frame or support assembly, and one or more cutting chains or chain sections that are affixed to certain components and/or at particular locations within the frame or assembly of the tool. Preferably, one end or location of the cutting chain is attached or otherwise engaged to a distal end of an arm. And, preferably, another end or location of the cutting chain is attached or engaged to a distal end of another arm. Most preferably, one end of the cutting chain is attached to one or more, and preferably a pair, of pivot plates which are attached or engaged to the noted distal end of the other arm.

The frame is comprised of one or multiple members arranged and configured as desired. In one version, a pair of frame members are spaced apart and affixed together by the use of a plurality of spacers and/or fasteners extending therebetween. The frame and/or its members include engagement provisions for releasable engagement with a press tool. The engagement provisions as will be understood are located along a proximate end or face of the cutting tool. Preferably, the engagement provisions include an aperture extending through the frame or frame members for receiving an engagement pin from the nose of the press tool. The distal end region of the frame or distal end regions of the frame members include provisions for attachment of a set of pivotable arms. The frame or support assembly can be an integral one piece member, or can be formed from a plurality of members. The preferred embodiments described later herein use frame assemblies that are formed from several components. This practice is favored as manufacturing costs are typically less as compared to forming an integral one piece unit.

The cutting tool also comprises a set of arms and preferably a pair of arms that are pivotably engaged with the frame assembly. Specifically, a first arm is pivotably engaged along one region of the frame and a second arm is pivotably engaged along another region of the frame. Preferably, the first arm and the second arm are disposed between two frame members.

The cutting tool also comprises a cutting chain, or a plurality of cutting chain sections. One end of the cutting chain or a link or region of the chain, is attached to a distal end of one of the arms as previously noted. And, another end of the cutting chain or a link or region of the chain or a different section of cutting chain is attached at a distal end of another arm of the cutting tool. The point of attachment is preferably at a distal end of the arm or in the near vicinity of the distal end. If multiple chain sections are used, it is preferred to provide releasable engagement provisions on corresponding ends of the cutting chain as described in greater detail herein. It will be understood that the term “chain sections” as used herein refers to portions of the overall cutting chain used in the cutting tool which can be selectively and readily engaged with one another. Preferably, the chain sections can be readily engaged with another and disengaged from one another without the use of any tools. Thus, a user can easily disengage two or more chain sections from one another manually. And, a user can easily engage or otherwise attach two or more chain sections to one another.

The cutting tool also comprises a feedscrew assembly that is in operable engagement with the cutting chain. The feedscrew assembly is preferably mounted on or integrally formed with one of the pivotable arms. The feedscrew assembly preferably includes a pair of arm extensions or a support base, a threaded longitudinal member, threaded trunnion retained and support by the pair of arm extensions, a pair of pivot plates, and a pivot pin disposed along an end of the threaded member. The pivot pin is generally supported within the pair of pivot plates. Upon rotating the threaded longitudinal member, the linear distance between (i) the trunnion which is retained between the arm extensions, and (ii) the pivot pin, which is supported within the pair of pivot plates, is changed. This dimensional change causes pivoting of the pivot plates relative to the arm at which the plates are attached. Since the cutting chain is attached to the pivot plates, pivoting of the plates thus causes a change in the effective length of the chain. Upon reducing the effective length, the chain can be tightened about a workpiece. Thus, the feedscrew assembly is preferably used to manually tighten or take up any slack in a cutting chain after the chain is positioned about a workpiece to be cut. Upon rotational adjustment of the feedscrew, the feedscrew is linearly displaced thereby pivoting the chain affixment member or pair of pivot plates relative to the corresponding arm and thereby changing the extent of slack in the chain.

As described in greater detail herein, the cutting chain, when having both ends or two region(s) coupled to the distal ends of the arms or a distal end of one arm and pivot plates associated with the other arm, defines a loop or bounded region. In order to cut or otherwise sever a pipe, positioned within the loop or bounded region, the press tool is actuated to decrease the size of the loop or bounded region, thereby eventually tightening the cutting chain about the outer periphery of the pipe until the pipe is cut, severed, or fractured. Upon actuation of the press tool, the arm distal ends are urged toward one another, thereby increasing the tension on the chain until ultimately, the pipe is severed or otherwise fractured. This bounded region is described in greater detail herein as a cutting confine.

Most preferably, the cutting tool comprises a pair of pivotally movable arms. The tool also comprises a pair of chain affixment members, each secured at a distal end of an arm. One of these chain affixment members is preferably in the form of a pair of pivot plates as previously described in association with the feedscrew assembly. The tool further includes a cutting chain with ends of the chain engaged to a corresponding chain affixment member associated with the other arm. And, the tool also comprises a feedscrew assembly mounted on one of the jaws and engaged with one of the chain affixment members, which as noted is preferably the pair of pivot plates. The chain affixment member or pair of pivot plates that is engaged with the feedscrew assembly is pivotally secured to a distal end of an arm. The other chain affixment member secured to the end of the other arm is preferably rigidly secured so that the member is not pivotable.

The preferred attachment tool includes several features as follows.

The arms are generally biased to an “open” position. Such open position is with reference to the distal ends of the arms. This refers to the distal ends being spaced apart from one another. Although such biasing can be implemented in a variety of ways and by various assemblies, it is preferred to dispose one or more biasing members between the arms such that the distal ends of the arms are biased or otherwise urged apart from one another.

The arms are preferably configured such that the extent of opening of the arms is limited to thereby reduce the extent of wasted stroke by the press tool. This aspect is preferably achieved by using particular geometrical configurations for the arms and spacing between the arms as depicted in the referenced figures.

The feedscrew assembly may also utilize multiple leads or threads having a relatively large pitch to thereby reduce the extent of feedscrew operation when removing slack from the cutting chain.

The preferred orientation of the feedscrew assembly is such that the feedscrew knob is directed away from the pipe. Or, restated, the feedscrew knob is preferably directed toward the user.

A significant feature of the pipe cutting tool described herein is the provision of a chain affixment member pivotally attached at an arm end, the position of which is adjusted by a feedscrew assembly to thereby change the amount of tension (or effective length) of the cutting chain. In a preferred version, this pivotally attached chain affixment member includes a pair of pivot plates.

Another significant feature of the tool described herein is the location of the feedscrew assembly in the tool. The feedscrew assembly is at least partly mounted and engaged with a chain affixment member, e.g. the pivot plates. Moreover, the preferred embodiment tool utilizes a feedscrew assembly that is mounted on only one arm. This reduces manufacturing complexity and facilitates use of the feedscrew.

All components of the preferred embodiment cutting tools described herein are formed of materials that exhibit sufficient strength, rigidity, and durability for repeated and consistent tool use. Preferably, the frame sections, arms, feedscrew components, and chain affixment members or pivot plates are formed from steel or other alloys of comparable strength. The cutting chain and associated cutting wheels, links, and posts are preferably formed from steel or other suitable materials. Hardened steel is preferred for the cutting wheels. In view of the high forces applied within the interior and to the frame assembly itself, it is preferred that the frame assembly be formed from metal and most preferably from steel. Nearly any grade of steel as used in the tooling arts is acceptable. One or more outer anti-corrosion layers or coatings may be used on all outer surfaces of the press frame and/or its various components.

The present invention cutting tool can be used to cut a wide range of pipe sizes, such as from 1½″ to 6″ size pipes. It will be understood that the present invention cutting tools can be used for cutting pipes having sizes different than these, for example smaller than 1½″, and/or greater than 6″.

Furthermore, although the present invention cutting tool has been described for cutting cast iron pipe, it will be appreciated that pipes of other materials can also be cut or otherwise severed using the present invention tool.

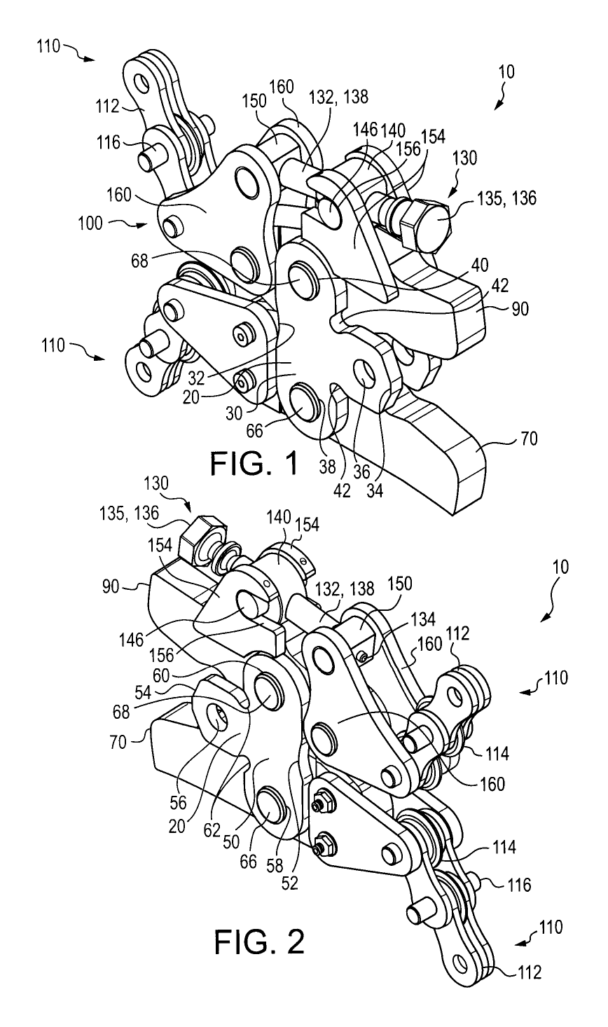

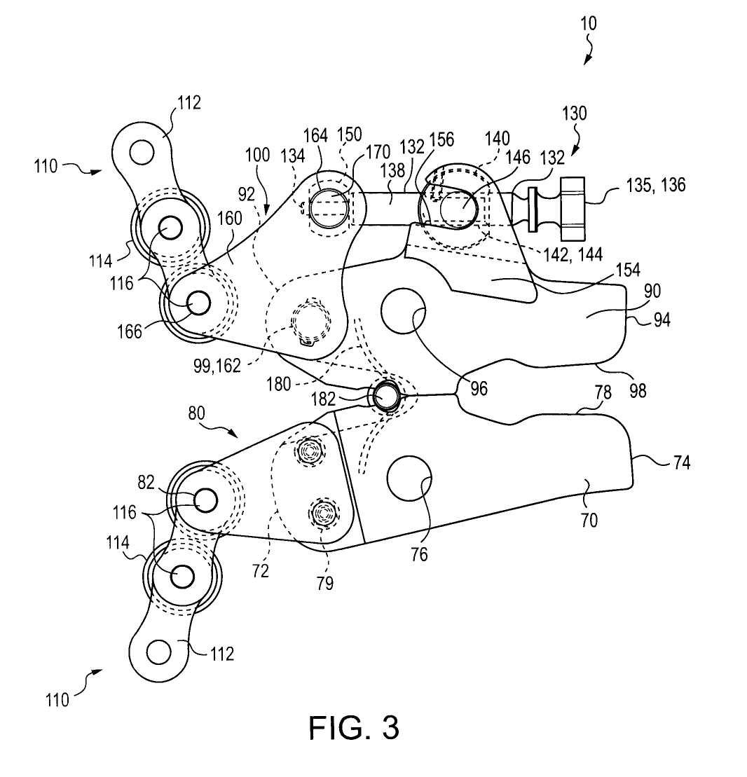

FIGS. 1-3 illustrate a preferred embodiment cutting tool 10 in accordance with the present invention. The tool 10 comprises a frame 20 (not shown in FIG. 3), which preferably includes a pair of arms pivotably engaged with the frame 20 such as a first arm 70 and a second arm 90. The tool 10 also comprises a cutting chain 110 extending between the arms 70, 90. And, the tool 10 further comprises a feedscrew assembly 130 generally carried on one of the arms, such as arm 90, and in operable engagement with the cutting chain 110. Preferably, the feedscrew assembly 130 is operably engaged with the cutting chain 110 by one or more pivot plates 160 engaged with and carried on the arm which carries the feedscrew assembly 130. All of these aspects are described in greater detail as follows.

Referring further to FIGS. 1 and 2, the frame 20 includes a first frame member 30 and a second frame member 50 generally oriented parallel to each other and spaced apart from each other. The first frame member 30 as best shown in FIG. 1, defines a distal end 32, a proximal end 34, and an engagement aperture 36 extending through the frame member 30. The first frame member 30 also defines a first arm pivot aperture 38 and a second arm pivot aperture 40. The first frame member 30 also defines two retention slots 42 generally located along opposite regions of a medial region of the frame member 30 within which the engagement aperture 36 is defined.

The second frame member 50 as best shown in FIG. 2, defines a distal end 52, a proximal end 54, and an engagement aperture 56 extending through the frame member 50. The second frame member 50 also defines a first arm pivot aperture 58 and a second arm pivot aperture 60. The second frame member 50 also defines two retention slots 62 generally located along opposite regions of a medial region of the frame member 50 within which the engagement aperture 56 is defined.

The tool also comprises the first and second arms 70 and 90, respectively. Each of the arms 70 and 90 is pivotally attached with the frame 20 as described in greater detail herein. As best illustrated in FIG. 3, the first arm 70 defines a distal or forward end 72 and an opposite proximal or rearward end 74. The first arm 70 defines a pivot engagement aperture 76 extending through the first arm 70. The arm 70 also defines a cam surface 78 for contacting a roller or other component of a press tool (not shown) when the tool 10 is engaged therewith. Engaged or otherwise formed with the arm 70 and preferably along the distal end 72 of the arm 70, is a chain affixment assembly 80. One or more apertures 79 defined in the arm 70 receive engagement members for attaching the chain affixment assembly 80 to the distal end 72 of the arm 70.

The second arm 90 defines a distal end 92 and an opposite proximal end 94. The second arm 90 defines a pivot engagement aperture 96 extending through the second arm 90. The arm 90 also defines a cam surface 98 for contacting a roller or other component of a press tool (not shown) when the tool 10 is engaged therewith. Engaged or otherwise formed with the arm 90 and preferably along the distal end 92 of the arm 90, is a pivotable chain affixment assembly 100. One or more apertures 99 defined in the arm 90 receive engagement members for attaching the pivotable chain affixment assembly 100 to the distal end 92 of the arm 90. The second arm 90 also preferably includes a feedscrew assembly support base 154 extending from the arm 90 and preferably from a medial region thereof. Details as to the support base 154 are provided in conjunction with the description of the feedscrew assembly 130.

The cutting tool 10 also comprises a pair of posts or members about which each arm pivots, and which serve to space apart and affix the frame members 30 and 50 to one another and the arms 70 and 90 therebetween. Specifically, the tool 10 comprises a first post 66 extending through the first arm pivot aperture 38 defined in the first frame member 30, the pivot engagement aperture 76 defined in the arm 70, and the first arm pivot aperture 58 defined in the second frame member 50. Similarly, the tool 10 also comprises a second post 68 extending through the second arm pivot aperture 40 defined in the first frame member 30, the pivot engagement aperture 96 defined in the arm 90, and the second arm pivot aperture 60 defined in the second frame member 50. Preferably, retaining rings are utilized in conjunction with the posts to retain the components in their assembled position.

As noted, the tool 10 also comprises a cutting chain 110. The cutting chain 110 includes a plurality of links 112 and a plurality of generally rotatable cutting members 114 engaged with one another by a plurality of engagement pins 116. One end or region of the cutting chain 110 is engaged with the chain affixment assembly 80 that is associated with the first arm 70. The other end or another region of the cutting chain 110 is engaged with the pivotable chain affixment assembly 100 that is associated with the second arm 90. The chain affixment assembly 80 defines a cutting chain engagement aperture 82, through which is received an engagement pin 116 of the chain 110.

The tool 10 also comprises a feedscrew assembly 130 that is generally carried on the second arm 90 and is preferably supported and engaged with the support base 154 extending from the second arm 90 and the pivotable chain affixment assembly 100 engaged along the distal end 92 of the second arm 90. Although the feedscrew assembly 130 is described and illustrated as affixed to the second arm 90, it will be appreciated that the invention includes embodiments in which the feedscrew assembly is indirectly affixed to the arm 90, or directly or indirectly affixed to the first arm 70. The feedscrew assembly 130 includes a longitudinal threaded feedscrew member 132 having a distal end 134 and an opposite proximal end 136. A knob 135 is preferably disposed or otherwise located along the proximal end 136 for facilitating grasping and rotating the feedscrew 132 about its longitudinal axis. The feedscrew 132 includes one or more outer threaded regions 138 extending between the ends 134 and 136. The feedscrew assembly 130 also includes a trunnion 140 defining a bore 142 extending through the trunnion 140. The bore 142 defines an interior threaded region 144 for threadedly receiving the feedscrew 132 along its threaded region 138. The trunnion 140 also preferably includes a pair of laterally projecting supports 146. The feedscrew assembly 130 also includes a capture member 150 that is movably affixed to the pivotable chain affixment assembly 100 associated with the second arm 90.

The feedscrew assembly support base 154 extends from the second arm 90 and preferably is in the form of a pair of spaced apart parallel members, each defining a slotted receiving region 156. The slotted receiving region 156 is generally accessible from a distal end of the tool 10. Each slotted receiving region 156 is sized, shaped, and configured to accept and retain the pair of laterally projecting supports 146 of the trunnion 140. The previously noted capture member 150 is configured to engage and retain the distal end 134 of the feedscrew 132, yet allow rotation of the feedscrew 132 about its longitudinal axis. It will be appreciated that upon rotation of the feedscrew 132, the distance between the capture member 150 and the trunnion 140 is changed, thereby causing pivotal displacement of the pivotable chain affixment assembly 100 associated with the second arm 90. Pivotable displacement of the assembly 100 results in tightening or loosening of the cutting chain 110 attached thereto, or as previously noted, reducing or increasing the cutting confine defined by the chain 110.

As noted, the pivotable chain affixment assembly 100 preferably includes a pair of pivot plates 160, each movably attached to the second arm 90, and preferably along the distal end 92 of the arm 90. The pivot plates 160 are preferably spaced apart and oriented generally parallel with one another. Specifically, as best shown in FIG. 3, each plate preferably defines an arm engaging aperture 162, a feedscrew pivot pin aperture 164 in a first location or locale, and a cutting chain engagement aperture 166 in a second location or locale. As will be appreciated, a retaining member or post extends through the arm engaging aperture 162 of each plate 160 and the aperture 99 defined in the arm 90. Similarly, a retaining pin, or a component of the capture member 150, or a separate feedscrew pivot pin 170 extends through the feedscrew pivot pin aperture 164 of each plate 160 and is coupled to the capture member 150. And, an engagement pin 116 of the chain 110 extends through the cutting chain engagement aperture 166 of each plate 160.

FIG. 3 illustrates the tool 10, however without the frame 20 and in particular, without the first and second frame members 30 and 50. FIG. 3 also shows the tool 10 without the posts 66 and 68. FIG. 3 reveals a retention member 182 disposed between the first and second arms 70 and 90. Specifically, the retention member 182 serves to retain a biasing member 180 that serves to urge the arms 70 and 90 to a predetermined default position. Typically, such position is such that the distal ends 72 and 92 of the first and second arms 70 and 90, respectively, are displaced and spaced apart from one another. This serves to increase the cutting confine defined by the cutting chain 110.

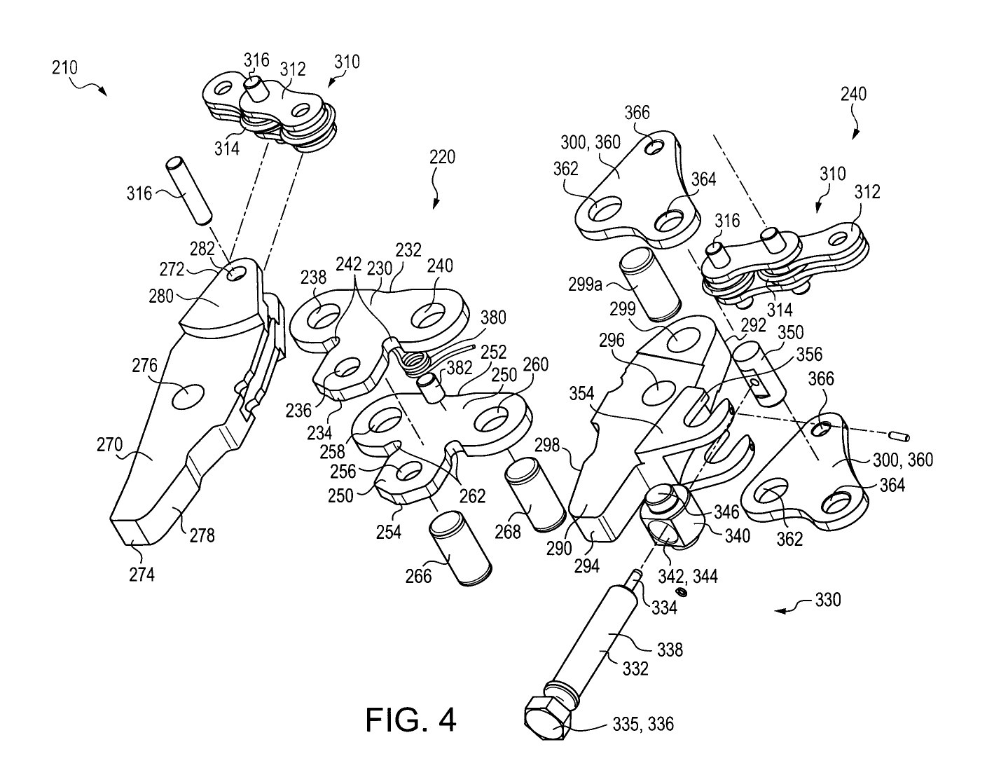

FIG. 4 is an exploded assembly view of another preferred embodiment tool 210. The tool 210 generally corresponds to the previously described tool 10 but for the end configuration of a cutting chain to distal regions of the arms. The tool 210 comprises a frame 220, which preferably includes a pair of arms pivotably engaged with the frame 220 such as a first arm 270 and a second arm 290. The tool 210 also comprises a cutting chain 310 extending between the arms. And, the tool 210 further comprises a feedscrew assembly 330 generally carried on one of the arms and in operable engagement with the cutting chain 310. Preferably, the feedscrew assembly 330 is operably engaged with the cutting chain 310 by one or more pivot plates 360 engaged with and carried on the arm which carries the feedscrew assembly 330. All of these aspects are described in greater detail as follows.

Referring further to FIG. 4, the frame 220 includes a first frame member 230 and a second frame member 250 generally oriented parallel to each other and spaced apart from each other. The first frame member 230 defines a distal end 232, a proximal end 234, and an engagement aperture 236 extending through the frame member 230. The first frame member 230 also defines a first arm pivot aperture 238 and a second arm pivot aperture 240. The first frame member 230 also defines two retention slots 242 generally located along opposite regions of a medial region of the frame member 230 within which the engagement aperture 236 is defined.

The second frame member 250 defines a distal end 252, a proximal end 254, and an engagement aperture 256 extending through the frame member 250. The second frame member 250 also defines a first arm pivot aperture 258 and a second arm pivot aperture 260. The second frame member 250 also defines two retention slots 262 generally located along opposite regions of a medial region of the frame member 250 within which the engagement aperture 256 is defined.

The tool also comprises the first and second arms 270 and 290, respectively. Each of the arms 270 and 290 is pivotally attached with the frame 220 as described in greater detail herein. The first arm 270 defines a distal end 272 and an opposite proximal end 274. The first arm 270 defines a pivot engagement aperture 276 extending through the first arm 270. The arm 270 also defines a cam surface 278 for contacting a roller or other component of a press tool (not shown) when the tool 210 is engaged therewith. Engaged or otherwise formed with the arm 270 and preferably along the distal end 272 of the arm 270, is a chain affixment assembly 280. One or more apertures 282 defined in the arm 270 receive engagement pins 316 for attaching the chain affixment assembly 280 to the cutting chain 310. In this embodiment, the chain affixment assembly 280 is integrally formed along the distal end 272 of the arm 270.

The second arm 290 defines a distal end 292 and an opposite proximal end 294. The second arm 290 defines a pivot engagement aperture 296 extending through the second arm 290. The arm 290 also defines a cam surface 298 for contacting a roller or other component of a press tool (not shown) when the tool 210 is engaged therewith. Engaged or otherwise formed with the arm 290 and preferably along the distal end 292 of the arm 290, is a pivotable chain affixment assembly 300. One or more apertures 299 defined in the arm 290 receive engagement members 299a for attaching the pivotable chain affixment assembly 300 to the distal end 292 of the arm 290, described in greater detail herein. The second arm 290 also preferably includes a feedscrew assembly support base 354 extending from the arm 290 and preferably from a medial region thereof. Details as to the support base 354 are provided in conjunction with the description of the feedscrew assembly 330.

The tool 210 further comprises a pair of posts 266 and 268. Upon assembly, the first post 266 extends through apertures 258 and 238 of the frame members 250 and 230, respectively. And, the post 266 also extends through the aperture 276 in the arm 270 disposed between the frame members 250 and 230. Similarly, the post 268 extends through apertures 260, 296, and 240. Retaining rings can be used in association with the posts to retain the posts in position within the various apertures.

The tool 210 also comprises a cutting chain 310. The cutting chain 310 includes a plurality of links 312 and a plurality of generally rotatable cutting members 314 engaged with one another by a plurality of engagement pins 316. One end or region of the cutting chain 310 is engaged with the chain affixment assembly 280 that is associated with the first arm 270. The other end or another region of the cutting chain 310 is engaged with the pivotable chain affixment assembly 300 that is associated with the second arm 290.

The tool 210 also comprises the feedscrew assembly 330 that is generally carried on the second arm 290 and is preferably supported and engaged with the support base 354 extending from the second arm 290 and the pivotable chain affixment assembly 300 engaged along the distal end 292 of the second arm 290. The feedscrew assembly 330 includes a feedscrew 332 having a distal end 334 and an opposite proximal end 336. A knob 335 is preferably disposed or otherwise located along the proximal end 336 for facilitating grasping and rotating the feedscrew 332 about its longitudinal axis. The feedscrew 332 includes one or more outer threaded regions 338 extending between the ends 334 and 336. The feedscrew assembly 330 also includes a trunnion 340 defining a bore 342 extending through the trunnion 340. The bore 342 defines an interior threaded region 344 for threadedly receiving the feedscrew 332 along its threaded region 338. The trunnion 340 also preferably includes a pair of laterally projecting supports 346. The feedscrew assembly 330 also includes a capture member 350 that is movably affixed to the pivotable chain affixment assembly 300 associated with the second arm 290.

The feedscrew assembly support base 354 extends from the second arm 290 and preferably is in the form of a pair of spaced apart parallel members, each defining a slotted receiving region 356. The slotted receiving region 356 is accessible from a distal end of the tool. Each slotted receiving region 356 is sized, shaped, and configured to accept and retain the pair of laterally projecting supports 346 of the trunnion 340. The previously noted capture member 350 is configured to engage and retain the distal end 334 of the feedscrew 332, yet allow rotation of the feedscrew 332 about its longitudinal axis. It will be appreciated that upon rotation of the feedscrew 332, the distance between the capture member 350 and the trunnion 340 is changed, thereby causing pivotal displacement of the pivotable chain affixment assembly 300 associated with the second arm 290. Pivotable displacement of the assembly 300 results in tightening or loosening of the cutting chain 310 attached thereto, or as previously noted, reducing or increasing the cutting confine defined by the chain 310.

As noted, the pivotable chain affixment assembly 300 preferably includes a pair of pivot plates 360, each movably attached to the second arm 290, and preferably along the distal end 292 of the arm 290. The pivot plates 360 are preferably spaced apart and oriented generally parallel with one another. Specifically each plate preferably defines an arm engaging aperture 362, a feedscrew pivot pin aperture 364 in a first location or locale, and a cutting chain engagement aperture 366 in a second location or locale. The arm engaging apertures 362 receive the engagement member 299a which is positioned in aperture 299 of the arm 290. The feedscrew pivot pin apertures 364 receive the capture member 350 which is affixed to the distal end 334 of the feedscrew 332. The cutting chain engagement apertures 366 receive an engagement pin 316 of the chain 310.

The tool 210 also comprises a retention member 382 disposed between the first and second arms 270 and 290. Specifically, the retention member 382 serves to retain a biasing member 380 that serves to urge the arms 270 and 290 to a predetermined default position.

The present invention also provides methods of severing, fracturing, and/or cutting workpieces such as pipes, and preferably relatively brittle pipes such as cast iron soil pipes by use of the present invention cutting tool. The methods generally comprise providing a cutting tool engaged with a press tool and identifying a location on a workpiece at which cutting is desired. The cutting chain is then wrapped about the outer periphery of the workpiece. Preferably, the cutting chain is aligned with or along the location of desired cutting on the workpiece. The cutting chain may remain attached to the tool at both of its ends, or one end of the cutting chain may be released or disengaged from the tool. Alternatively, a component to which the cutting chain is attached can be disengaged from the cutting tool. Once one or both ends of the chain are disengaged from the tool, the loose end of the chain can be wrapped about the workpiece and positioned along the desired cutting line or location. The one or both ends of the chain are then engaged with the cutting tool. Any slack existing in the cutting chain is then readily removed or taken up by adjustment of the feedscrew assembly. As the chain is tightened about the workpiece, the chain is located or it is otherwise confirmed that the chain is positioned along the desired location for cutting on the workpiece. Once the chain has been tightened by the feedscrew assembly, the press tool is actuated to extend a powered ram to thereby pivotally displace the arms as described herein. This causes further tightening of the cutting chain about the workpiece and application of relatively large forces upon the workpiece thereby eventually resulting in fracture, severing, or cutting of the workpiece.

In a particularly preferred version of the cutting tool, the tool includes a scoring provision for forming one or more indentations into the outer surface of the workpiece at a desired cutting location. The use of the scoring provision typically produces a “cleaner” cut face than cutting without such scoring provision. The term “cleaner” cut face refers to the resulting cut face more closely corresponding to the desired location for cutting. Generally, when cutting a cast iron pipe, it is desired to cut the pipe so as to produce a cut face which is generally perpendicular to the longitudinal axis of the pipe, and which is relatively uniform, free of ridges or other deviations from the plane of cut. Cutting operations using the scoring provision provide a remarkable smooth and clean cut face.

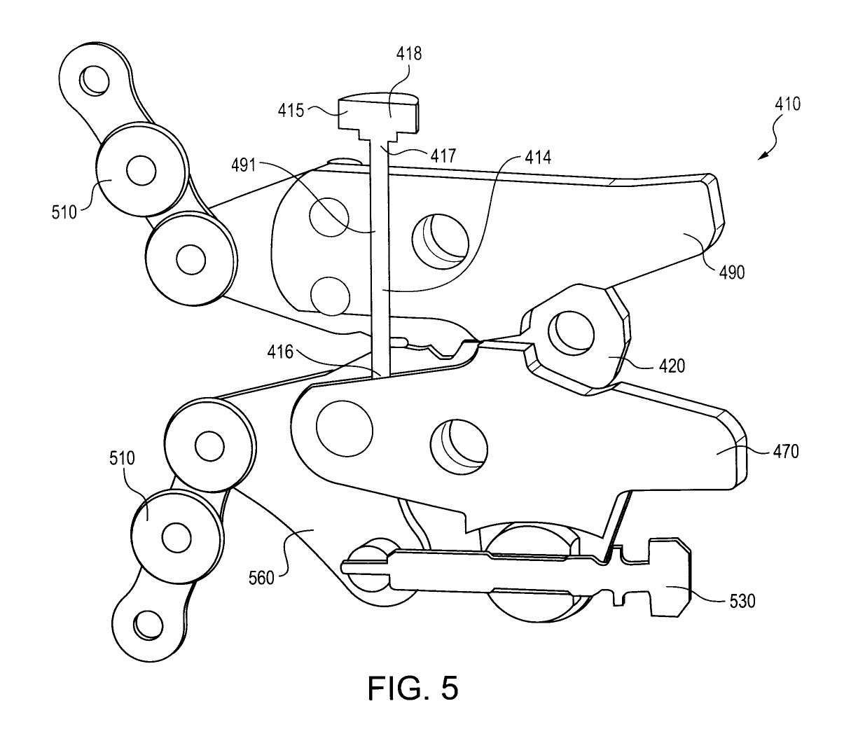

FIG. 5 illustrates yet another preferred embodiment cutting tool in accordance with the invention compromising in part, a preferred scoring provision. Specifically, FIG. 5 depicts a preferred cutting tool 410 in accordance with the present invention. The tool 410 comprises a frame 420 which preferably includes a pair of arms pivotably engaged with the frame 420 such as a first arm 470 and a second arm 490. Each arm defines distal ends 472, 492 and proximal ends 474, 494. It will be appreciated that the cutting tool 410 is shown without one of its frame members to better reveal the interior configuration of the tool. The tool 410 also comprises a cutting chain 510 extending between the arms 470, 490. And, the tool 410 further comprises a feedscrew assembly 530 generally carried on one of the arms 470, and in operable engagement with the cutting chain 510. Preferably, the feedscrew assembly 530 is operably engaged with the cutting chain 510 by one or more pivot plates 560 engaged with and carried on the arm which carries the feedscrew assembly 530. The details and components of the preferred embodiment cutting tool 410 generally correspond to those of previously described cutting tools 10 and 210, and so reference can be made to the descriptions herein associated with FIGS. 1-4.

The preferred embodiment cutting tool 410 comprises a scoring provision, generally denoted as 415 in FIG. 5. The scoring provision 415 is generally in the form of a longitudinal threaded member 414 defining an engagement end 416 and an oppositely located adjusting end 417. A knob 418 or other grip promoting member is preferably disposed along the adjusting end 417. One or more threaded regions are defined along the member or portions thereof, between the ends 416 and 417.

The cutting tool 410 preferably defines a threaded aperture in one of the arms 470, 490, and preferably extending generally transversely through the other arm, opposite the arm that carries the feed screw assembly 530. Thus, in the version of the tool 410 depicted in FIG. 5, the arm 490 defines the noted threaded aperture, shown as aperture 491. The longitudinal member 414 is threadedly received and engaged within the arm 490 and specifically within the aperture 491.

Referring further to FIG. 5, it will be appreciated that the scoring provision 415 and its receiving aperture 491 are located forwardly of the pivot locations of the arms 470 and 490. That is, the arms 470 and 490 pivot about posts (not shown) that extend through pivot apertures 476 and 496 defined in the arms and frame, such as frame 420 and its counterpart frame member (not shown). The scoring provision 415 is located between these pivot locations and the cutting chain 510. Moreover, the scoring provision 415 is closer to a distal or forward end 492 of the arm 490 than a proximal or rearward end 494 of the arm 490.

In a particularly preferred configuration of the cutting tool 410, the scoring provision is rotatably positionable between a “cut” (or unscrewed) position and a “score” (or screwed in) position. Thus, when the scoring provision is in the cut position, the engagement end 416 is brought into relatively close proximity to the underside of the arm 490, or even fully retracted within the aperture 491. And when the scoring provision is in the score position, the engagement end 416 is spaced from the underside of the arm 490. Preferably, when in the score position, and when the cutting chain 510 and arms 470, 490 are positioned so that the chain 510 is tightly extending about a workpiece to be cut, the end 416 of the longitudinal member 414 contacts the upper side (as shown in FIG. 5) of the arm 470. This configuration is further described herein association with an operational description of scoring a pipe prior to cutting, using the preferred embodiment cutting tool 410.

A cutting operation using the scoring provision 415 is preferably performed as follows. A user wraps or otherwise positions the cutting chain 510 about a pipe or other workpiece to be cut as previously described herein. The feed screw assembly 530 is tightened to thereby remove any slack from the chain 510. The user then sets the scoring provision to one of the two noted positions—“cut” or “score”. To perform a scoring operation, the user rotates the longitudinal member 414 to the “score” position thereby generally extending the end 416 from the arm 490. The user then actuates the press tool thereby causing further tightening of the chain 510 about the pipe. Contact between the end 416 of the longitudinal member 414 of the scoring provision and the arm 470 prevents a full cutting operation from occurring. Instead, the cutting wheels of the chain 510 are pressed into the outer surface of the pipe thereby forming at least one and preferably plurality of spaced apart linear indentations along the pipe exterior, all extending circumferentially about the desired cut line. This aspect of forming the indentations as opposed to performing a full cutting operation, is referred to herein as “controllably forming”. The user then releases the cutter, i.e. releases application of force to the cutting tool to be incrementally rotated or slightly orbited about the pipe. Preferably, the extent of rotational repositioning of the cutting chain and the tool is such so that the cutting wheels are each brought to a new location along the outer surface of the pipe, between two of the previously noted indentations. The user then positions the scoring provision to the “cut” position and actuates the press tool. The jaws 470 and 490 are then permitted to be displaced toward one another to further tighten the cutting chain 510 about the pipe. It has been surprisingly discovered that as cutting occurs and as fractures form within the pipe sidewall, the fractures typically extend along the desired cutting line. Use of the scoring provision is optional as it may be left in its “cut” position during all phases of operation of the cutting tool. It will be appreciated that the present invention includes numerous variations and alternate configurations of the scoring provision, cutting tools including such provisions, and related methods. Therefore, it will be understood that in no way is the invention limited to any of the details described herein.

Although the present invention cutting tool has been described for use with a powered press tool using a hydraulic cylinder, it will be appreciated that the present invention cutting tool can be used with nearly any type of powered ram, manual ram, or mechanical assemblies. For example, a variety of force multiplying assemblies could be used to provide a force input to the pivoting arm components of the present invention tools. Thus, it is contemplated that the cutting tools can be used with pneumatically driven rams or mechanical assemblies that provide a powered ram or other component for engaging the arms in the present invention tool.

Although it is preferred that the preferred embodiment cutting tools are used by attachment or coupling to a hand-held portable, typically electrically powered, press tool; it will be appreciated that the tools can be used with a wide array of other force-generating devices. Further, it is not necessary that the preferred embodiment cutting tools be used in conjunction with hand-held press tools. Instead, the cutting tools can be used with non-portable or stationary press tools. And, it will be readily understood that the preferred embodiment cutting tools can be used with a variety of press tools or force-generating assemblies that are not battery powered, but instead, powered from other machine or human powered sources.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present invention includes any and all combinations of components or features of the embodiments described herein.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. A pipe cutting tool adapted for engagement to a press tool having an extendable powered ram, the cutting tool comprising:
a frame assembly defining a first region and a second region;
a first arm pivotally engaged with the first region of the frame assembly, the first arm defining a proximal end and an opposite distal end;
a second arm pivotally engaged with the second region of the frame assembly, the second arm defining a proximal end and an opposite distal end;
a pivot plate assembly pivotally engaged with the distal end of the second arm, the pivot plate assembly defining a first locale and a second locale;
a cutting chain attached to the distal end of the first arm and also attached to the first locale of the pivot plate assembly; and
a feedscrew assembly engaged with the second arm and the second locale of the pivot plate assembly;
wherein upon adjustment of the feedscrew assembly, the position of the pivot plate assembly relative to the second arm is changed, thereby changing the cutting confine defined by the cutting chain.

2. The pipe cutting tool of claim 1 wherein the frame assembly includes a first frame member and a second frame member spaced apart from one another, both the first arm and the second arm being disposed between the first and second frame members.

3. The pipe cutting tool of claim 1 wherein the feedscrew assembly includes:
a longitudinal threaded member defining a proximal end and an opposite distal end;
a support base projecting from the second arm, the base defining a slotted receiving region;
a trunnion defining a threaded bore extended through the trunnion;
wherein the longitudinal threaded member is threadedly engaged within the bore of the trunnion, the trunnion is supported and retained by the support base, and the distal end of the longitudinal threaded member is engaged with the second locale of the pivot plate assembly.

4. The pipe cutting tool of claim 3 wherein the feedscrew assembly further includes a knob affixed to the proximal end of the longitudinal threaded member.

5. The pipe cutting tool of claim 1 further comprising a biasing member disposed between the first arm and the second arm and configured to urge the arms to a default position.

6. The pipe cutting tool of claim 5 wherein the default position is such that the distal ends of the first arm and the second arm are spaced apart from one another.

7. The pipe cutting tool of claim 1 further comprising:
a scoring provision for controllably forming a plurality of indentations about an outer surface of a pipe to be cut by the cutting tool.

8. The pipe cutting tool of claim 7 wherein the first arm defines a threaded aperture extending through the first arm, the scoring provision including:
a longitudinal member threadedly engaged within the aperture and positionable between a cut position and a score position.

9. A pipe cutting tool adapted for engagement to a press tool having an extendable powered ram, the cutting tool comprising:
a frame assembly defining a first region and a second region;
a first arm pivotally engaged with the first region of the frame assembly, the first arm defining a proximal end and an opposite distal end;
a second arm pivotally engaged with the second region of the frame assembly, the second arm defining a proximal end and an opposite distal end;
a pivot plate assembly pivotally engaged with the distal end of the second arm, the pivot plate assembly including a first pivot plate and a second pivot plate, the first and second pivot plates spaced apart and pivotably coupled to the distal end of the second arm disposed therebetween, the first and second plates defining a first aperture and a second aperture;
a cutting chain attached to the distal end of the first arm and also attached to the first aperture defined by the pivot plates; and
a feedscrew assembly engaged with the second arm and the second aperture of the pivot plates;
wherein upon adjustment of the feedscrew assembly, the position of the pivot plate assembly relative to the second arm is changed, thereby changing the cutting confine defined by the cutting chain.

10. The pipe cutting tool of claim 9 wherein the frame assembly includes a first frame member and a second frame member spaced apart from one another, both the first arm and the second arm being disposed between the first and second frame members.

11. The pipe cutting tool of claim 9 wherein the feedscrew assembly includes:
a longitudinal threaded member defining a proximal end and an opposite distal end;
a support base projecting from the second arm, the base defining a slotted receiving region;
a trunnion defining a threaded bore extended through the trunnion;
wherein the longitudinal threaded member is threadedly engaged within the bore of the trunnion, the trunnion is supported and retained by the support base, and the distal end of the longitudinal threaded member is engaged with the second aperture of the pivot plates.

12. The pipe cutting tool of claim 11 wherein the feedscrew assembly further includes a knob affixed to the proximal end of the longitudinal threaded member.

13. The pipe cutting tool of claim 9 further comprising a biasing member disposed between the first arm and the second arm and configured to urge the arms to a default position.

14. The pipe cutting tool of claim 13 wherein the default position is such that the distal ends of the first arm and the second arm are spaced apart from one another.

15. The pipe cutting tool of claim 9 further comprising:
a scoring provision for controllably forming a plurality of indentations about an outer surface of a pipe to be cut by the cutting tool.

16. A pipe cutting tool adapted for engagement to a press tool having an extendable powered ram, the cutting tool comprising:
a frame assembly defining a first region and a second region;
a first arm pivotally engaged with the first region of the frame assembly, the first arm defining a proximal end and an opposite distal end;
a second arm pivotally engaged with the second region of the frame assembly, the second arm defining a proximal end and an opposite distal end;
a pivot plate assembly pivotally engaged with the distal end of the second arm, the pivot plate assembly defining a first locale and a second locale;
a cutting chain attached to the distal end of the first arm and also attached to the first locale of the pivot plate assembly; and
a feedscrew assembly engaged with the second arm and the second locale of the pivot plate assembly, the feedscrew assembly including a longitudinal threaded member defining a proximal end and an opposite distal end, a support base projecting from the second arm, the base defining a slotted receiving region, a trunnion defining a threaded bore extended through the trunnion, wherein the longitudinal threaded member is threadedly engaged within the bore of the trunnion, the trunnion is supported and retained by the support base, and the distal end of the longitudinal threaded member is engaged with the second locale of the pivot plate assembly;
wherein upon adjustment of the feedscrew assembly, the position of the pivot plate assembly relative to the second arm is changed, thereby changing the cutting confine defined by the cutting chain.

17. The pipe cutting tool of claim 16 wherein the frame assembly includes a first frame member and a second frame member spaced apart from one another, both the first arm and the second arm being disposed between the first and second frame members.

18. The pipe cutting tool of claim 16 wherein the feedscrew assembly further includes a knob affixed to the proximal end of the longitudinal threaded member.

19. The pipe cutting tool of claim 16 further comprising a biasing member disposed between the first arm and the second arm and configured to urge the arms to a default position.

20. The pipe cutting tool of claim 19 wherein the default position is such that the distal ends of the first arm and the second arm are spaced apart from one another.

21. The pipe cutting tool of claim 16 wherein the pivot plate assembly includes a first pivot plate and a second pivot plate spaced apart from one another and pivotably coupled to the distal end of the second arm disposed therebetween.

22. The pipe cutting tool of claim 16 further comprising:
a scoring provision for controllably forming a plurality of indentations about an outer surface of a pipe to be cut by the cutting tool.

23. A method of cutting a pipe, the method comprising:
providing a pipe cutting tool including a frame assembly, a first arm pivotally engaged with the frame assembly, the first arm defining a proximal end and an opposite distal end, a second arm pivotally engaged with the frame assembly, the second arm defining a proximal end and an opposite distal end, a pivot plate assembly pivotally engaged with the distal end of the second arm, a cutting chain attached to the distal end of the first arm and also attached to the pivot plate assembly, and a feedscrew assembly engaged with the second arm and the pivot assembly, the tool in operable engagement with a press tool;
providing a pipe to be cut;
identifying a desired cutting location on the pipe;
positioning the cutting chain of the cutting tool about the pipe and generally co-extending with the desired cutting location;
removing at least a portion of slack from the cutting chain by adjusting the feedscrew assembly; and
actuating the press tool to cause powered pivotal displacement of the first arm and the-second arm thereby tightening the cutting chain about the pipe thereby resulting in cutting of the pipe.

24. The method of claim 23 wherein the pipe cutting tool includes a scoring provision, the method comprising:
prior to actuating the press tool to result in cutting of the pipe, positioning the scoring provision to a first position such that upon actuation of the press tool, at least one indentation is formed along an outer surface of the pipe;
actuating the press tool to form the at least one indentation;
positioning the scoring provision to a second position;
actuating the press tool to thereby cut the pipe generally along the at least one indentation.
